(19) United States
(12) Patent Application Publication
(10) Pub. No.: US 2005/0238854 A1
(43) Pub. Date: Oct. 27, 2005

(54) Dinner mat

(75) Inventor: Ben Hsu, Changhua Hsien (TW)

Correspondence Address: TROXELL LAW OFFICE PLLC, SUITE 1404, 5205 LEESBURG PIKE, FALLS CHURCH, VA, 22041, US

(73) Assignee: Ching Feng Blinds Ind. Co., Ltd.

(21) Appl. No.: 10/890,118

(22) Filed: Jul. 14, 2004

(30) Foreign Application Priority Data
Apr. 21, 2004 (TW) 093206153

(51) Int. Cl. B32B 3/00

(52) U.S. Cl. 428/195.1

(57) ABSTRACT

A dinner mat includes a mat embodiment with a protective decoration layer of a proper thickness coated at the surface of both top and bottom sides thereon respectively wherein the protective decoration layer thereof is made of a plurality of protruded decorative spots or thin films that are distributed at both surfaces of the mat embodiment thereon. The mat embodiment thereof can also have the protruded decorative spots disposed at one side thereon, and the thin films coated at the other side thereof. Besides, the protruded decorative spots or the thin films can be randomly dispersed or artistically arranged into diagrams at both sides of the mat embodiment thereon. Otherwise, the protective decoration layers thereof can be fully extended to cover the whole surface of the mat embodiment thereof. In practical use, the protective decoration layers can better protect the surfaces of the mat embodiment and reduce the abrasion of the dinner mat. Via the protective decoration layers thereof, the dinner mat is double-side usable and exchangeable to achieve appealing visual effect of the dinner mat in decoration. And depending on the degree of the abrasion of the dinner mat, the mat embodiment can also be reversibly turned from one side to the other for replacement, efficiently prolonging the using lifetime and reducing the cost of the replacement of the dinner mat thereof so as to boost the competitive power of the present invention in the market.

### BACKGROUND OF THE INVENTION

The present invention is related to a dinner mat, including a mat embodiment with a protective decoration layer of a proper thickness coated at both top and bottom surfaces thereon respectively wherein the protective decoration layer thereof is made of a plurality of protruded decorative spots or thin films that are randomly distributed or artistically arranged into diagrams at both surfaces of the mat embodiment thereon; whereby, the protective decoration layers can better protect the surfaces of the mat embodiment and reduce the abrasion of the dinner mat in practical use. Via the protective decoration layers thereof, the dinner mat is double-side usable and reversibly exchangeable from one side to the other for replacement to achieve appealing visual effect of the dinner mat in decoration as well as to prolong the lifetime of the dinner mat in use, efficiently boosting the competitive power of the present invention in the market.

A conventional dinner mat is made up of a mat embodiment with diagrams directly printed and exposed at the surface of one side thereon, which is single-side usable for application onto a table or on the ground for picnics. In practical use, the diagrams disposed at one surface of the dinner mat are directly and frequently contacted with articles like dinnerware put thereon, which can easily result in the abrasion of the dinner embodiment thereof and destroy the beauty of the dinner mat as a whole. Thus, such conventional dinner mat is easily worn out of normal operation and reduced in the using lifetime thereof.

### SUMMARY OF THE PRESENT INVENTION

It is, therefore, the primary purpose of the present invention to provide a dinner mat, including a mat embodiment with a protective decoration layer of a proper thickness coated at the surface of both sides thereon respectively; whereby, the protective decoration layers can better protect both surfaces and reduce the abrasion of the mat embodiment thereof in practical use so as to prolong the using lifetime of the dinner mat thereof.

It is, therefore, the second purpose of the present invention to provide a dinner mat wherein, via the protective decoration layers coated at the surface of both sides of the mat embodiment thereof, the dinner mat is double-side usable and reversibly exchangeable from one side to the other for replacement to achieve appealing visual effect of the dinner mat in decoration as well as to reduce the cost of replacement thereof, efficiently boosting the competitive power of the present invention in the market.

### BRIEF DESCRIPTION OF THE DRAWINGS

FIG. 1 is a perspective view of the present invention.

FIG. 2 is a cross sectional view of the present invention.

FIG. 3 is another cross sectional view of the present invention.

FIG. 4 is a third cross sectional view of the present invention.

### DETAILED DESCRIPTION OF THE PREFERRED EMBODIMENTS

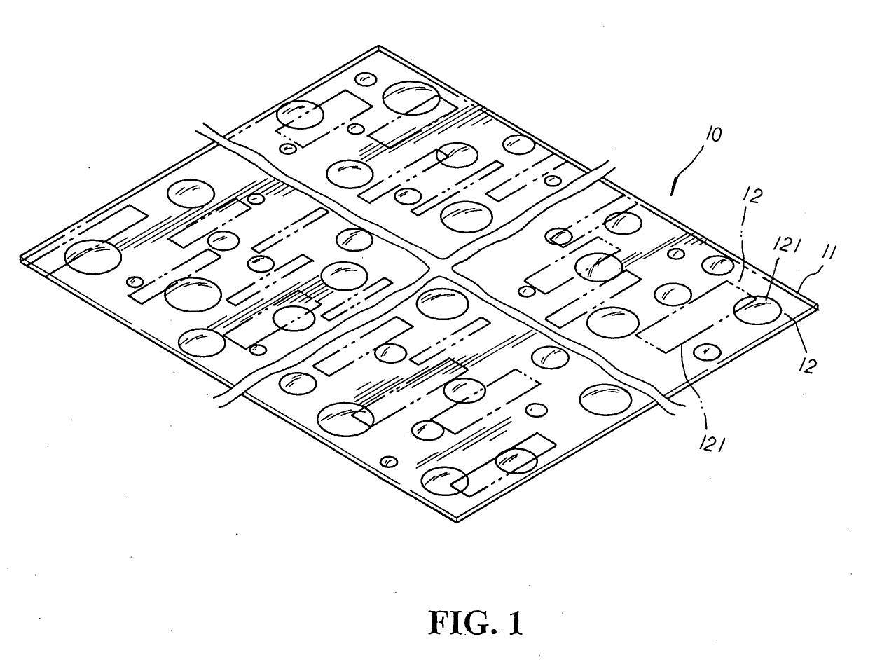

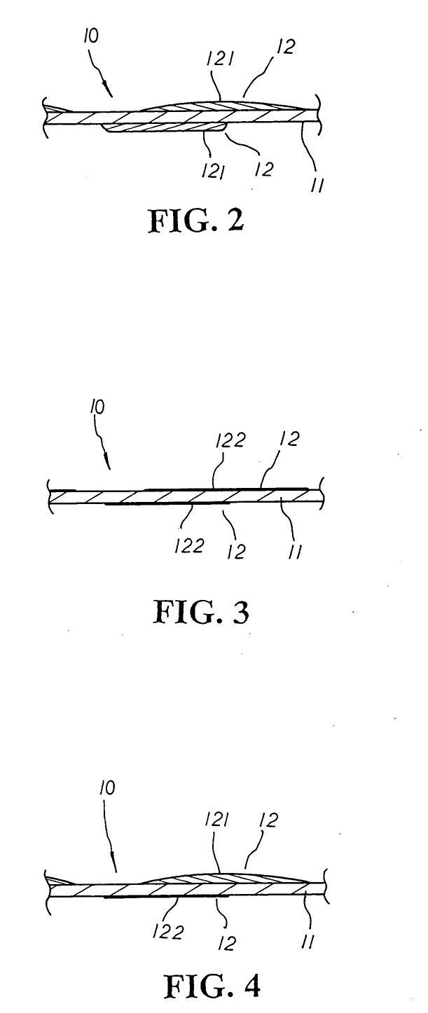

Please refer to FIGS. 1 to 4 inclusive. The present invention is related to a dinner mat, including a dinner mat 10 made up of a mat embodiment 11 with a protective decoration layer 12 of a proper thickness coated at the surface of both sides thereon respectively. The protective decoration layer 12 can be made of a plurality of protruded decorative spots 121 as shown in FIG. 2, or thin films 122 as shown in FIG. 3. Both top and bottom sides of the mat embodiment 11 thereof can be provided with either all the protruded decorative spots 121 or all the thin films 122 as shown in FIGS. 1 and 2 respectively. Otherwise, the mat embodiment 11 can also have the protruded decorative spots 121 disposed at one side thereon, and the thin films 122 coated at the other side thereon as shown in FIG. 4. Besides, the protruded decorative spots 121 or the thin films 122 can be randomly dispersed or artistically arranged into diagrams at both sides of the mat embodiment 11 thereon. Otherwise, the protective decoration layers 12 can be fully extended to cover the whole surface at both sides of the mat embodiment 11 thereof. In practical use, the protective decoration layers 12 coated at both sides of the mat embodiment 11 thereon can better protect the surfaces and reduce the abrasion of the mat embodiment 11 thereof for longer using lifetime of the dinner mat 10 thereof. Via the protective decoration layers 12 disposed at both sides of the mat embodiment 11 thereof, the dinner mat 10 is double-side usable and exchangeable for appealing visual effect of the dinner mat 10 in decoration. And, depending on the degree of the abrasion of the dinner mat 10, the mat embodiment 11 can also be reversibly turned from one side to the other for replacement, efficiently prolonging the using lifetime of the dinner mat 10 and reducing the cost of the replacement thereof so as to boost the competitive power of the present invention in the market.

1. A dinner mat, having a mat embodiment with a protective decoration layer of a proper thickness coated at the surface of both sides thereon respectively wherein the protective decoration layers are formed higher than the surfaces of the mat embodiment thereof, permitting the protective decoration layers to better protect the surfaces and reduce the abrasion of the mat embodiment in practical use; thus, via the protective decoration layers disposed at both sides of the mat embodiment thereof, the dinner mat is double-side usable and exchangeable to achieve appealing visual effect of the dinner mat in decoration; besides, depending on the degree of the abrasion of the dinner mat, the mat embodiment can also be reversibly turned from one side to the other for replacement, efficiently prolonging the using lifetime and reducing the cost of the replacement of the dinner mat thereof so as to boost the competitive power of the present invention in the market.

2. The dinner mat as claimed in claim 1 wherein the protective decoration layer thereof can be made of a plurality of protruded decorative spots or thin films.

3. The dinner mat as claimed in claim 1 wherein both top and bottom sides of the mat embodiment thereof can be provided with the protective decoration layers formed of the protruded decorative spots thereof.

4. The dinner mat as claimed in claim 1 wherein both top and bottom sides of the mat embodiment thereof also be provided with the protective decoration layers formed of the thin films.

5. The dinner mat as claimed in claim 1 wherein the mat embodiment thereof can also have the protruded decorative spots disposed at the surface of one side thereon, and the thin films coated at that of the other side thereon.

6. The dinner mat as claimed in claim 1 wherein the protruded decorative spots or the thin films can be randomly dispersed or artistically arranged into diagrams at both top and bottom sides of the mat embodiment thereon; otherwise, the protective decoration layers thereof can be fully extended to cover the whole surface at both sides of the mat embodiment thereon.
